(19) United States
(12) Patent Application Publication
(10) Pub. No.: US 2016/0160625 A1
(43) Pub. Date: Jun. 9, 2016

(54) Method for developing oil or natural gas shale or tight rock formations in two step process

(71) Applicant: Tim Maloney, Houston, TX (US)

(72) Inventor: Tim Maloney, Houston, TX (US)

(73) Assignee: Era Exploration LLC, Houston, TX (US)

(21) Appl. No.: 14/560,763

(22) Filed: Dec. 4, 2014

(51) Int. Cl. E21B 43/26; G06Q 50/02; G06Q 10/06; E21B 7/06; E21B 33/124

(52) U.S. Cl. CPC E21B 43/26; E21B 7/06; E21B 33/124; G06Q 10/0635; G06Q 50/02

(57) ABSTRACT

A method for developing oil or natural gas shale or tight rock formations by constructing wells in a two step process. The method includes an algorithm for determining under what conditions this two step process is the preferred option for developing a shale or tight rock resource. Step one is to drill a multilateral well with a profusion of unstimulated open-hole laterals from a main wellbore, after which the well is produced for a period of time. Step two is to re-enter the well and install a multistage hydraulic fracture completion. The method includes drilling the main bore and laterals in a specific sequence and geometry to facilitate running a frac liner in the future when the multistage fracturing step is carried out.

### TECHNICAL FIELD OF THE INVENTION

The present invention relates generally to the recovery of subterranean resources, and more particularly to a method for enabling commercial production of oil or natural gas from tight rock formations.

### BACKGROUND OF THE INVENTION

Subterranean deposits of shale or tight rock that contain natural gas or oil are assumed to require hydraulic fracturing during the original drilling in order to create sufficient contact surface area and flow paths to enable production of commercial quantities of hydrocarbons. However, in certain planned or unplanned cases, these same formations have been drilled and put on production before the wells were hydraulically fractured. In some of these cases the wells produced substantial quantities of oil and/or natural gas prior to hydraulic fracturing. These wells already had the expensive equipment installed required for hydraulically fracturing, but the fracturing was delayed for either reservoir evaluation purposes or mechanical problems, thus preventing the fracturing at the time of original drilling. Even so, the quantities of oil or gas produced from these wells were deemed insufficient to economically justify drilling more of these type of unfractured wells. There are three reasons for this: 1) the wells were drilled to optimize the performance of the hydraulic fracturing (not for an unfractured well in shale/tight rock), 2) the capital cost included the downhole equipment for fracturing (thus requiring higher oil/gas flow rates to meet economic hurdles), and 3) the flowrates from these unfractured wells did not have the high initial peak rates associated with hydraulically fractured wells (on the other hand, the decline rates in these unfractured wells were not as severe as the fractured wells). So, if the economics of an unfractured multilateral well can be improved by drilling it to optimize its unstimulated flow capacity and by not installing the expensive equipment for fracturing at the outset, then these types of wells have a place in the overall development of shale or tight rock formations under certain conditions.

In the United States when developing onshore shale or tight rock oil or natural gas resources the normal practice is for the operator to lease the minerals from the mineral owner with a 3 to 5 year period in which commercial production must be established in order to hold the lease. If commercial production is not established within this time, then the lease expires and the operator no longer has access to the minerals. This practice is a carryover from conventional onshore oil and gas developments in which the fields are much smaller in overall acreage and the construction of the infrastructure facilities needed to support the drilling campaigns can be completed within this time frame. However, in most shale or tight rock plays the overall acreage positions are much, much larger, so these individual lease timeframes (3-5 years) are often out of sync with the time to complete the supporting infrastructure projects (pipelines; batteries; oil, water and gas processing plants; and public infrastructure [roads, bridges, power transmission, water, human resources, etc.]. This disconnect between the timing of individual leases and infrastructure projects causes additional costs and inefficiencies for operators because they rush to build whatever infrastructure they can to handle the wells being drilled to avoid lease expirations, only to go back and redo much of this infrastructure later as the play matures and the ultimate size and volumes are better understood. So, a two step process where leases are initially held by drilling lower cost unfractured wells could help sync up the timing of the subsequent hydraulic fracturing step with the completion of the supporting infrastructure projects. This could improve the overall economics of the entire play by helping to right size the infrastructure projects and to conduct the hydraulic fracturing step in a more orderly and efficient manner.

### SUMMARY OF THE INVENTION

The present invention provides a method to drill an oil or gas well in a shale or tight rock formation in a two step process, first as an unfractured multilateral well, and later, re-entered and completed as a multistage hydraulically fractured well. The method is designed to optimize both the initial unfractured multilateral well and the future multistage fracture completion. The initial unfractured multilateral well is optimized by drilling numerous side laterals as quickly and cheaply as possible to effect the maximum reservoir contact surface area at the lowest capital cost. The future multistage completion is optimized by having a main wellbore with high integrity to allow the frac string (liner, swell packers, frac sleeves) to be run smoothly and for the isolation swell packers to be set securely between the side laterals, thus enabling a multistage hydraulic fracturing job to be performed successfully. Hence, a key feature of this method is to drill the side laterals quickly and cheaply, but to ensure the main wellbore is smooth, straight and to gauge. One embodiment of this method is depicted in the figures and is described below. This embodiment shows a drilling sequence from heel-to-toe, in which the main lateral is drilled out in individual steps, each one made up of a short straight hole section and then backing up to perform the side lateral kick out in either direction. These side lateral kick outs can be made with various directional tools which direct the drill bit in a combined sideways and upward orientation so that the main wellbore remains the straight bore ready for the next deepening step. Once the side lateral has made most of its turn away from the main wellbore, it will continue to be drilled within the targeted zone for the intended distance. After which the drilling assembly is readied for the next short straight section.

Given the importance of maintaining a smooth main wellbore, the side laterals are drilled in such a way as to not unduly damage the main wellbore. This can include, for example, not attempting to re-enter a side lateral if it would create excessive wash-outs in the main wellbore. Hence, when drilling problems prevent one of the side laterals from reaching its intended distance, it would be left that way and the drilling would proceed on to the next section.

In order to prepare for the future frac string installation the main wellbore is cleaned with at least one wiper run and, if any wellbore damage is suspected, a log is run to identify where the good and bad sections are located. This will allow the swell packers to be spaced along the frac string so that they are set in gauge hole sections.

During the second step, when the well is re-entered and prepared for multistage hydraulic fracturing, it will similarly begin with gauge and wiper runs to ensure the main wellbore is clean and able to accept the frac string all the way to bottom. Once the frac string is run and the swell packers have set, then the multistage fracturing treatment is carried out.

In addition to these technical components, the method includes an algorithm for determining under what conditions this two step process is the preferred option for developing a shale or tight rock resource. A figure of a flow chart is used to describe one embodiment of a decision process an operator can follow in determining when to apply this two step well type.

### BRIEF DESCRIPTION OF THE FIGURES

For a more complete understanding of the present invention and its advantages, reference is now made to the following description taken in conjunction with the accompanying drawings, wherein like numerals represent like parts, in which:

FIG. 1 is a perspective view illustrating the overall surface and subterranean positioning of one embodiment of the present invention showing one well with forty side laterals in the middle of implementing step 2, the hydraulic fracturing step.

FIGS. 2A, 2B and 2C are top views of the horizontal section only as it is being constructed in step 1, that is, the unfractured multilateral well. In this embodiment the final step 1 well is shown in FIG. 2C with forty side laterals off one main wellbore.

FIGS. 3A, 3B and 3C are top views of the horizontal section only during the beginning of step 2 when the frac string is being run into the main wellbore.

FIGS. 4A, 4B, 4C and 4D are top views during the end of step 2 when the actual hydraulic fracturing is being performed, with the final fractured well shown in FIG. 4D.

FIG. 5 is a flow chart showing one embodiment of a decision process an operator can follow in determining when to apply this two step method.

### DESCRIPTION OF A PREFERRED EMBODIMENT

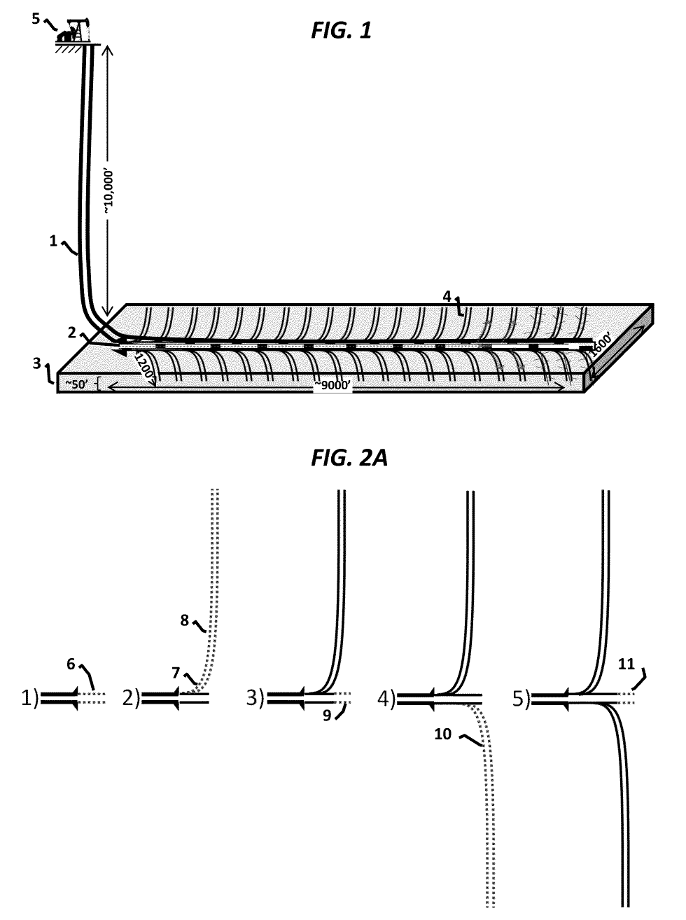

Referring to FIG. 1 there is shown a well comprising a cased wellbore 1 connecting the surface facilities 5 to the lowest casing shoe 2, below which extends the main horizontal wellbore. The side laterals 4 extend in both directions off the main wellbore. Both the main horizontal wellbore and side laterals are drilled largely within the targeted shale or tight rock zone 3. This figure shows the well during step 2 when the frac string has been run and the fracturing treatments are underway. It depicts the bottom six side laterals as already being fractured, with the next four laterals underway.

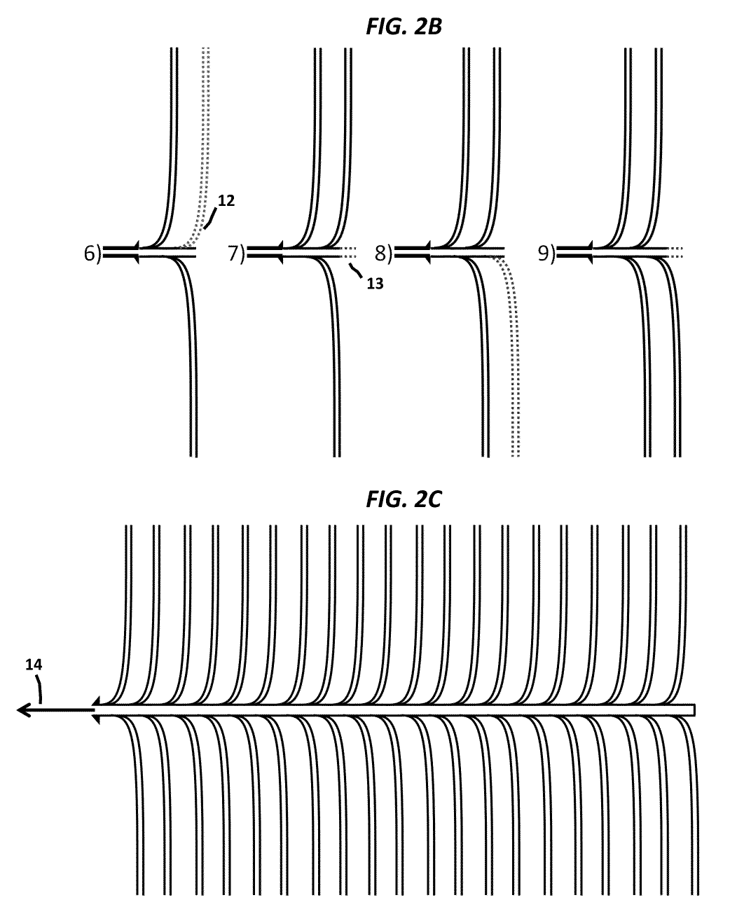

FIG. 2 shows the construction of the step 1 multilateral well. As shown in FIG. 2A, it begins with drilling a short section 6 out from the casing shoe. Depending on where the casing shoe is landed, this short open hole section may be just a few hundred feet long, or may be longer if the casing shoe is still a further distance from the target zone. The drill assembly is then configured for directional drilling and pulled back up-hole to the intended kickoff point. The kickoff is oriented up and to the left to initiate a side lateral on the left side of the main wellbore. The first part of the side lateral 7 is drilled with an aggressive directional tool to effect a rapid turn toward the targeted orientation. Once this orientation is established the distal portion of the side lateral 8 is drilled. This may still include directional drilling to effect a curved pathway along the side lateral to intersect faults, natural fractures and sub-zones within the overall target zone. After the side lateral has reached its final depth, the directional tool is configured for straight drilling and the drilling assembly is pulled back into the main wellbore. Another short section 9 is drilled out from the main wellbore. Then the process repeats itself, configuring for directional drilling, pulling back and kicking off to drill a second lateral 10. Once completed, another short straight section 11 is drilled out. This pattern continues in FIG. 2B, with a third side lateral 12, another short straight section 13, and so forth. The final embodiment with forty side laterals is shown in FIG. 2C. Once the well is put on production the flow of fluids from the laterals and main wellbore are depicted by the arrow 14.

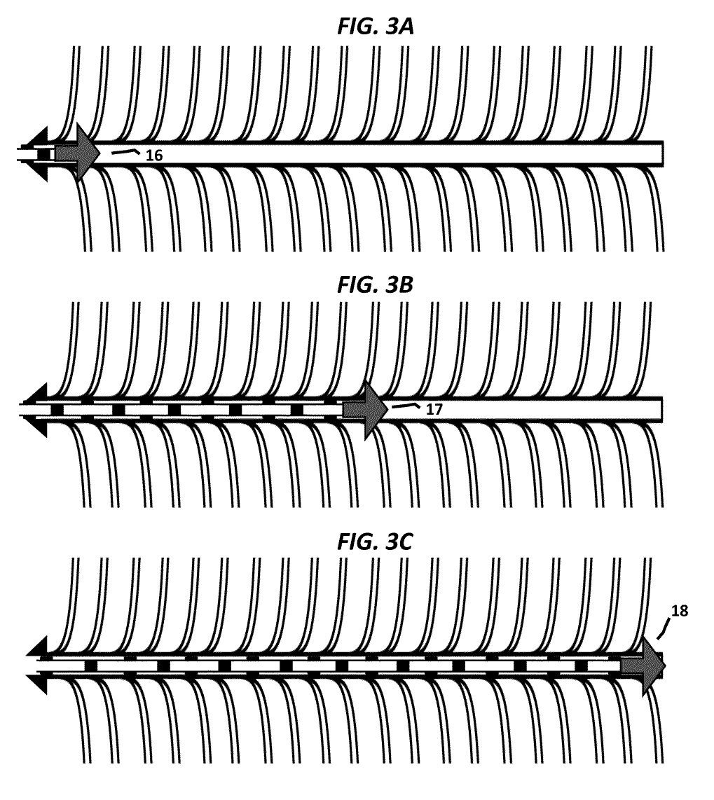

FIG. 3 shows commencement of step 2, the multistage hydraulic fracturing. This begins with the running of the frac string, which is depicted in FIGS. 3A, 3B and 3C with the running in positions shown 16, 17 and finally when total depth is reached 18. The swell packers are spaced to land between the side laterals so that they provide pressure isolation between sets of side laterals. The swell packers are set either automatically (temperature or contact with reservoir fluids), hydraulically or mechanically.

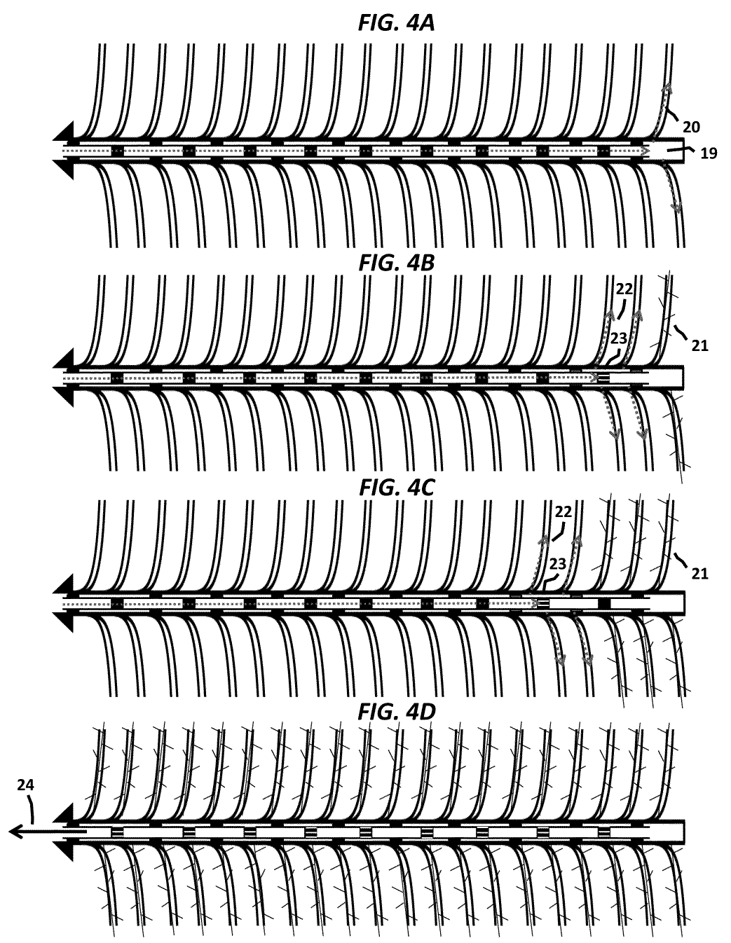

FIG. 4 shows the actual hydraulic fracturing of step 2. FIG. 4A shows the fracturing beginning with the bottom two side laterals. The frac fluid is shown as a dashed line arrow that runs inside the frac liner to the bottom open hole section 19. From there the frac fluid and proppants are pumped into the side laterals 20. In FIG. 4B and 4C the process continues to the second and third stages of fracturing by the opening of a frac sleeve 23, which then allows the next stage to be pumped into the next set of side laterals 22 between the next set of swell packers. This process repeats itself until all the frac stages have been pumped, as depicted in FIG. 4D. Once the well is again put on production the flow of fluids from the laterals and main wellbore are depicted by the arrow 24.

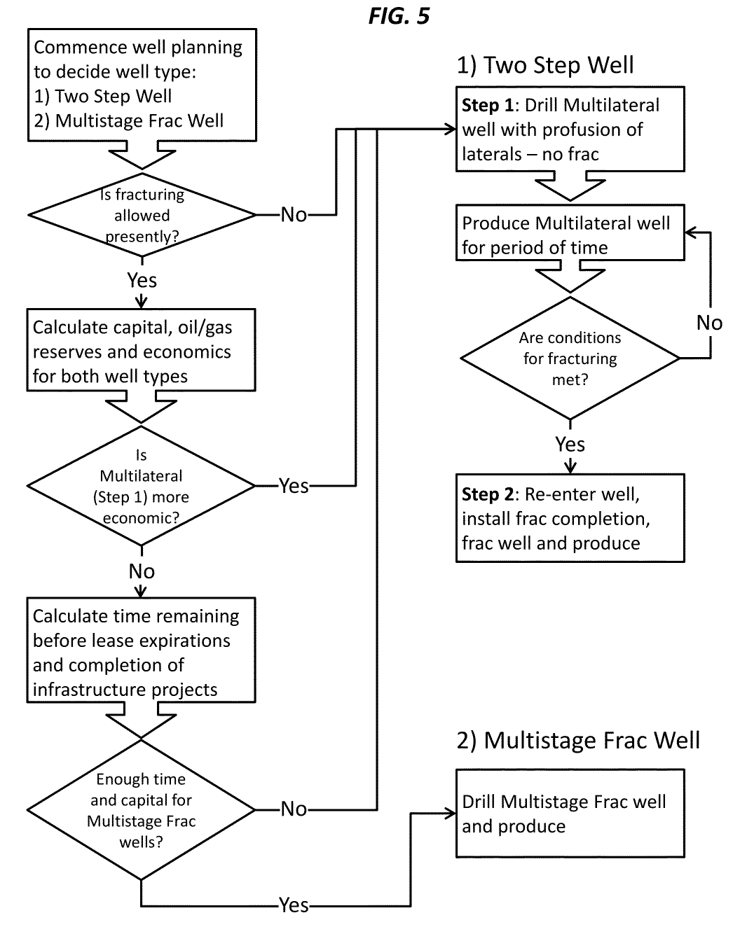

FIG. 5 is a flow chart showing one embodiment of a decision process an operator can follow in determining when to apply this two step method. It begins with a well planning process in which the two alterative well types, 1) Two Step Well and 2) Multistage Frac Well, are considered. The first decision is whether fracturing is even allowed at the present time at the well location. If not, then the Two Step well is selected because it does not require hydraulic fracturing. If fracturing is allowed, then the second process step is to calculate the economics of both well types. This is a complex process that considers the capital, oil and gas reserves, commodity prices and other factors. If the Multilateral well is actually more economic than the Multistage Frac well, then the Two Step well is selected. If not, then the third process step is to calculate the time remaining until lease expirations and completion of infrastructure projects. This step is when the individual well type decision is considered within the context of the operator's broader acreage position and infrastructure projects. That is, it may be more economic to drill a Two Step Multilateral well in order to conserve capital until more held acreage has been accumulated and/or until some of the infrastructure projects are completed.

On the right column of FIG. 5 the Two Step process is depicted. Step 1 is to drill the Multilateral well and put it on production for a period of time. The final decision point in the flow chart is determining when (or if) the well should be re-entered to complete Step 2 to perform hydraulic fracturing.

What is claimed is:

1. A method for developing subterranean oil or natural gas shale or tight rock formations, comprising the following steps:
(1) drilling a multilateral well, without hydraulically fracturing, and placing the well on production for a period of time;
(2) re-entering the well, installing multistage hydraulic fracturing equipment, fracturing the well and placing the well back on production.

2. The method of claim 1, wherein the subterranean formation contains hydrocarbons within one or more of the following rock types: shale, mudstones, siltstones, sandstones, dolomites, carbonates, clay-rich limestone, clay rich silt and other low permeability mineral deposits.

3. A method of claim 1 wherein the step 1 multilateral well is constructed as follows:
(a) drilling the vertical portion of the well from the surface to a location just above or within the target formation with a casing shoe as the lowest piece of equipment;
(b) drilling a short open hole section out from the casing shoe to a position about 100 feet beyond the first kickoff point;
(c) configuring bottom hole assembly for directional drilling, backing up to first kickoff point and initiating a side lateral in an upward and side orientation;
(d) drilling side lateral, initially with an aggressive directional tool to effect a rapid turn toward the targeted orientation and then more gradually for remainder of lateral with some curvature to intersect faults, natural fractures and sub-zones within the overall target zone;
(e) after the side lateral reaches its final depth, or as deep as deemed sufficient, the directional tool is configured for straight drilling, is pulled back into the main wellbore and another short straight extension is drilled out;
(f) repeating this process of drilling side laterals and extending the main wellbore in short sections until the planned number of laterals are completed;
(g) running a wiper and gauge tool to clean out main wellbore, and, if necessary, a log to identify hole condition along the main wellbore, before completing the well and putting it on production.

4. A method of claim 1 wherein the step 2 multistage hydraulic fracturing is constructed as follows:
(a) re-entering well and running a wiper and gauge tool to ensure main wellbore is clean able to accept the frac string all the way to bottom;
(b) running frac string until the swell packers are best situated laterals so they provide pressure isolation between sets of side laterals;
(c) setting swell packers (automatically, mechanically, hydraulically);
(d) pumping first stage of multistage hydraulic fracturing treatment;
(e) opening frac sleeve and pumping second stage of multistage hydraulic fracturing treatment;
(f) repeating this process of opening frac sleeves and pumping next stage of frac treatment until all frac stages are completed;
(g) installing remaining completion equipment and putting well back on production.

5. A method for deciding under what conditions this two step method is the preferred option for developing a shale or tight rock resource, comprising the steps of:
(a) determining whether hydraulic fracturing is allowed at the well location at the present time;
(b) calculating the capital, oil and gas reserves, commodity prices and other factors needed to determine the economics of the two step well type compared to the typical shale well that includes multistage hydraulic fracturing during original drilling;
(c) calculating the time remaining before lease expirations and infrastructure projects are completed to determine whether it is more economic to drill a two step well type in order to conserve capital until more acreage has been accumulated and/or until some of the infrastructure projects are completed.
(d) in the cases where a step 1 multilateral well has been drilled, determining when (or if) the well should be re-entered to complete step 2 to perform hydraulic fracturing.
